(19) United States
(12) Patent Application Publication
(10) Pub. No.: US 2023/0046625 A1
(43) Pub. Date: Feb. 16, 2023

(54) SYSTEM FOR MANAGING PRODUCT STOCKS WHICH IS SUITABLE FOR HOUSEHOLD USE

(71) Applicant: SQUIKIT, Torcy (FR)

(72) Inventors: Grégory MEUNIER, Pomponne (FR); Benjamin LEFRANCOIS, Massy (FR); Jean-François QUINTARD, Villejuif (FR)

(21) Appl. No.: 17/759,307

(22) PCT Filed: Jan. 25, 2021
(86) PCT No.: PCT/EP2021/051637

§ 371 Date: Jul. 22, 2022

(30) Foreign Application Priority Data
Jan. 23, 2020 (FR) FR2000649

(51) Int. Cl. G06Q 10/08; G06K 7/10

(52) U.S. Cl. CPC G06Q 10/087; G06K 7/10227

(57) ABSTRACT

The system (1) comprises a plurality of products stored in dedicated product containers (RC), a computer server (S RC) hosting a product stock management software module (GSP, GS) and connected to an extended data communication network (IP), a weighing device (BC) interconnected with the computer server (S-RC) through a wireless data communication link (RWF, L5) and through the extended data communication network, and a user computer device (UD) connected to the computer server and hosting a software application (APPLI), the product containers each comprising an identification tag storing an identification number, and the weighing device comprising an identification reader module. According to the invention, the reader module is a radio-identification reader module and the tag is a radio-identification tag having a location distance from a placement surface of the container which is at most equal to a radio detection height of the reader module from a weighing surface (SP) of the weighing device, and the weighing device comprises an accelerometer and means arranged so as ensure that the weighing device is put on standby, or woken up, on the basis of movement information supplied by the accelerometer.

The invention relates, in a general manner, to monitoring assistance and replenishing stocks of products and foodstuffs. More particularly, the invention relates to a system for managing product stocks which is suitable for household use, but not exclusively.

For most people, management of food supplies and products necessary for day-to-day life is a chore. Taking stock of what is needed, and drawing up a shopping list, are time-consuming and energy-consuming tasks, which often cause significant mental strain and stress. However, they are essential for more intelligent consumption and reduction in spending and wastage. Unnecessary purchases, omissions, and additional trips to shops are often the consequence of a shopping list that is incorrect, incomplete, or quite simply missing, or which is based on over-confidence in one's memory.

Various solutions have been developed and are proposed for preparing shopping lists and for food stock management.

Thus, in order to draw up simple shopping lists, voice assistances, such as Amazon Alexa® or Google Home®, can be used, and avoid manual entry.

Connected devices are commercially available and comprise functions for food stock tracking, drawing up shopping lists, or ordering shopping which can be delivered to the home. A refrigerator equipped with a camera which allows for viewing of stocks contained in the apparatus and which facilitates drawing up of a shopping list and ordering of products is known. A multicooker having a function for drawing up a shopping list associated with one or more culinary preparations is also commercially available. Connected buttons are also available, and make it possible, by simple pressing, to add specific products to a shopping list, for example, for ordering, and for home delivery.

Software applications which can be used on a Smartphone have enjoyed some success, and provide services such as tracking of food stocks with alerts relating to expiry dates or low levels, menu suggestions, and creating shopping lists. These software applications generally require manual capture of a large amount of information by the user, in particular stock movement information. This manual capture is a significant disadvantage and limits the practical usefulness of these software applications.

The association of a wireless barcode reader with the software application makes it possible to reduce the amount of information captured by the user, allowing certain and reliable identification of products. Adding products to the stock is also proposed, from reading a checkout ticket using the camera of a Smartphone. The solutions above simplify the task of the user. However, this capture remains necessary for indicating quantities, weights, or the like. Obtaining this quantity, weight or other information may cause difficulties for the user, in particular when the products are loose or require weighing.

The document US20170161676A describes an inventory management system that is suitable for tracking food stock contained in receptacles. The receptacles are provided with an electronic device fixed by an adhesive. The electronic device comprises a sensor for measuring the filling of the receptacle, an order controller, human/machine interface means, network connectivity means, and an autonomous electrical supply. Tables for tracking stock, present in a computer server, are updated on the basis of update data sent by the electronic devices to the receptacles. The update data are transmitted to the computer server via a local network and the Internet network. A mobile device, such as a tablet or Smartphone, hosts a software application and allows for local wireless communication with the electronic devices of the receptacles, as well as remote communication with the computer server, via the Internet network. A button is also provided in the human/machine interface means of the electronic device of the receptacle, in order to manually indicate to the computer server a need for restocking.

The document WO2019/156650A1 describes connected scales with which an optical barcode (or QR code) reader is associated, for management of product stocks. The managed products are identified by a barcode label. The scales indicate the current weight of the product weighed, and transmit this on a data communication network, with the identification code of the product. An automatic product control process is activated when the current weight of the product falls below a predetermined threshold. In an embodiment, the automatic product control process informs the user of the threshold being exceeded, by way of their Smartphone, which is connected to the network and hosts a dedicated software application. Various purchasing options from online merchants are then proposed to the user in order to complete the product stock. A computer server is connected to the data communication network, and stores the product data, the quantities, the orders, etc. The online merchants have access to the server and to order and product information concerning them. Various automatic ordering methods are available for users, and facilitate just-on-time delivery of consumable products.

The object of the present invention is that of obtaining a system for managing product stocks which is suitable for household use and which does not have the above-mentioned disadvantages of the prior art, capable of precisely quantifying the stock stage of products and of providing complete shopping lists, while making the fewest possible demands of the user.

According to a first aspect, the invention relates to a system for managing product stocks comprising a plurality of products stored in product containers, a computer server hosting a product stock management software module and connected to an extended data communication network, a weighing device interconnected with the computer server via a wireless data communication link and via the extended data communication network, and in data communication with the product stock management software module, and a user computer device connected to the computer server via the extended data communication network and hosting a software application and in data communication with the product stock management software module, the product containers each being provided with an identification tag storing an identification number, and the weighing device comprising an identification reader module, and the weighing device comprising means arranged so as to control reading of the identification number in the identification tag by the identification reader module during an operation of weighing the product container and to transmit a weight measurement of the product container and the read identification number to the computer server hosting the product stock management software module. According to the invention, the identification reader module is a radio-identification reader module, and the identification tag is a radio-identification tag having a location distance with respect to a placement surface of the product container which is at least equal to a radio detection height of the radio-identification reader module from a weighing face of the weighing device, and the weighing device comprises an accelerometer and means arranged so as to ensure putting on standby, or waking, of the weighing device, on the basis of movement information provided by the accelerometer.

In the system for managing product stocks according to the invention, the weighing device is a connected mobile object having an autonomous electrical supply and wireless data communication means. The possibility of moving the weighing device without wiring constraints, and of being able to bring it as close as possible to the storage locations of the product containers, is a significant feature, which grants a high degree of flexibility and promotes optimum acceptance of the system of the invention in various household environments.

Moreover, the radio-identification technology used offers the advantage of facilitating the weighing operation for the user, compared with an apparatus using “MRCS” (“Machine Readable Code Scanner”) technology, which calls on barcodes or QR codes. Indeed, in the “MRCS” technology, the optical reading principle requites the identification tag not only to be close to the reader module, but also to be facing said module, and the user must therefore pay attention to the orientation of one with respect to the other. This is not the case for the system of the present application, because, in the case of the radio-identification technology used, it is the distance between the identification tag and the reader module which takes precedence, the orientation of one with respect to the other having a limited effect. This thus results in a simplification of the handling of the product container by the user, who does not have to ensure a defined orientation thereof.

The accelerometer and the means for putting on standby/waking up, provided in the weighing device, allow for a reduction of the electrical consumption thereof, in particular by stopping the radio-identification reader module during periods of inactivity. The electrical consumption of the radio-identification reader is dominant in the energy balance of the weighing device, and stopping it during periods of inactivity increases the usage period of the weighing device between two electrical recharges.

In the system of the present application, the feature of fixing the radio-identification reader module in the bottom part of the product container allows for minimization of the distance between the radio-identification tag and the radio-identification reader module. The reading of the radio-identification tag is facilitated, and, consecutively, it is possible to use a radio-identification reader module in a lower power class. A reduction in the cost of the weighing device and an increase in the electrical autonomy thereof, due to a reduced electrical consumption of the radio-identification reader, can thus be achieved.

According to a particular feature of the system of the invention, the radio-identification reader module is included in a power class allowing a radio detection height of between 2 cm and 3.5 cm.

According to another particular feature, the radio-identification reader module is included in a power class allowing a radio detection height of between 0.5 cm and 2 cm.

According to another particular feature, the extended data communication network is the Internet network.

According to another particular feature, the user computer device is a Smartphone, a tablet, or a computer connected to the Internet network.

According to another particular feature, the radio-identification tag and the radio-identification reader module are of the “RFID” type.

According to yet another particular feature, the system also comprises a router modem which obtains a local data communication network and access to the extended data communication network, the weighing device being interconnected with the computer server via the local data communication network.

According to yet another particular feature, the router modem and the local data communication network are of the “Wi-Fi” type, and the weighing device comprises a radio communication module of the “Wi-Fi” type.

According to yet another particular feature, the router modem is of the type referred to as “ADSL,” optical, satellite, and/or cellular radiotelephony in “3G,” “4G” or “5G” mode.

According to yet another particular feature, the system comprises a local data communication link between the weighing device and the user computer device hosting the software application, the local data communication link being used by a configuration function of the weighing device actuated by means of the software application.

Other advantages and features of the present invention will emerge more clearly upon reading the detailed description, below, of a plurality of particular embodiments of the invention, with reference to the accompanying drawings, in which:

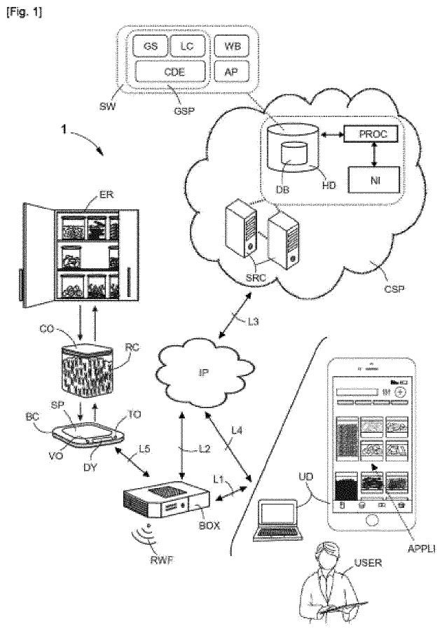

FIG. 1 is a simplified general view of a particular embodiment of the system for managing product stocks according to the invention.

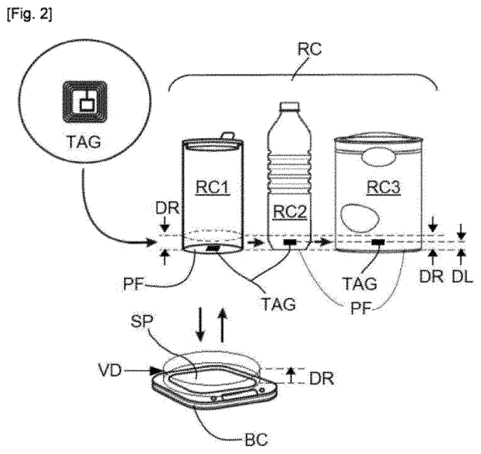

FIG. 2 is a perspective view of a plurality of product containers included in the system for managing product stocks of FIG. 1.

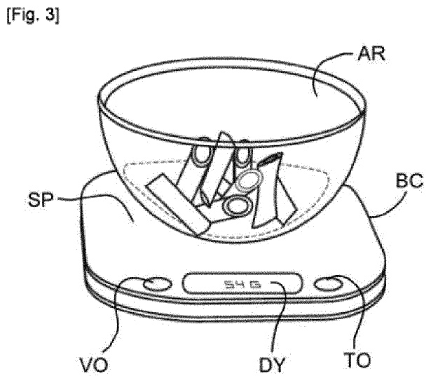

FIG. 3 is a perspective view showing the weighing of a container not recognized by connected scales of the system for managing product stocks of FIG. 1.

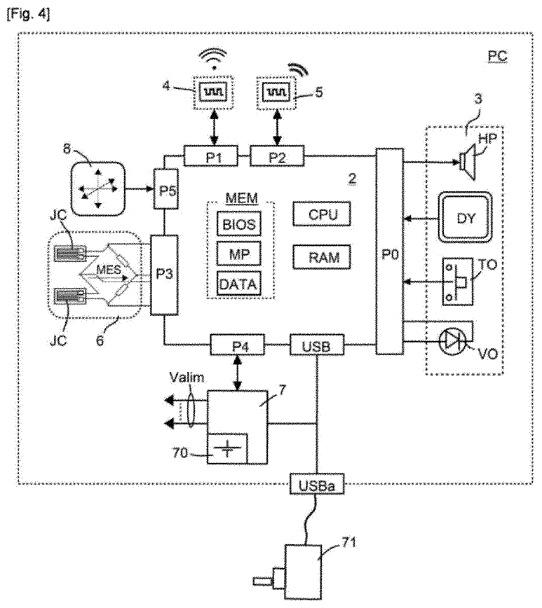

FIG. 4 is a simplified view showing the electronic architecture of the scales connected to the system for managing product stocks of FIG. 1.

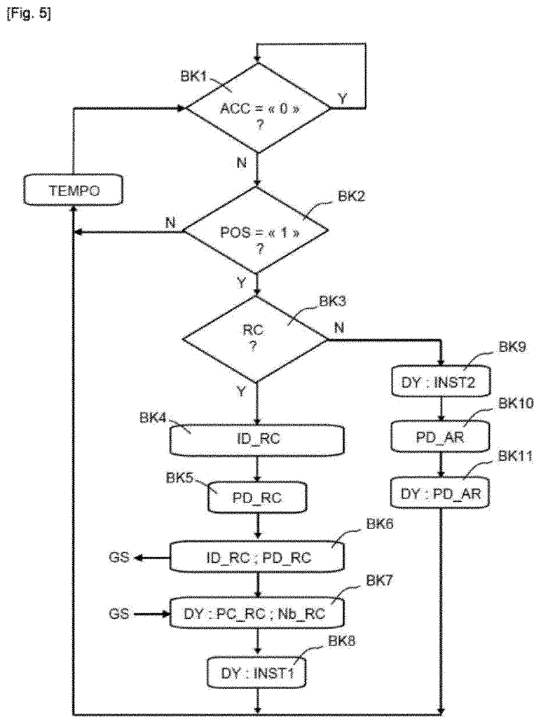

FIG. 5 is an algorithm relating to the functioning of the scales connected to the system for managing product stocks of FIG. 1.

In the following description, by way of explanation and in a non-limiting manner, specific details are provided in order to allow for understanding of the technology described. It will be obvious to a person skilled in the art that other embodiments may be implemented outside of the specific details described below. In other cases, the detailed descriptions of well-known methods, devices, techniques, etc. are omitted in order not to complicate the description with unnecessary details.

In a general manner, it will be understood that the term “product” used in the present description refers to different types of products, such as a coffee pod, pasta, sugar, or the like, which can be quantified by a weight or by a number of units. Thus, products said to be “loose,” generally without packaging, such as caster sugar, etc., are quantified by weight. The products having unit packaging, such as coffee pods, coffee filters, washing powder tablets, etc., are quantified by the number of units.

With reference to FIGS. 1 and 5, in the following, by way of example, a particular embodiment 1 of a system according to the invention for managing product stocks will be described.

With reference more particularly to FIG. 1, the system 1 according to the invention is implemented via an extended data communication network IP, such as the Internet network, and uses hardware and software resources which are accessible via said network. Thus, in this embodiment, the system 1 uses software and hardware resources available at a cloud computer services provider CSP “cloud service provider.”

The system 1 uses at least one computer server SRC of the cloud computer services provider CSP. The computer server SRC in particular comprises a processor PROC which communicates with a data storage device HR, typically dedicated to the system 1, and conventional hardware devices such as network interfaces NI and other devices (not shown). The processor PROC comprises one or more central data processing units (not shown) and volatile and non-volatile memories (not shown) for the execution of computer programs.

The system 1 comprises a software system SW which is hosted in the data storage device HD, together with a user database DB. The data storage device HD typically comprises one or more hard disks.

The system 1 according to the invention is implemented in particular by the execution, by the processor PROC, of code instructions of the software system SW. The software system SW, for example of the “SaaS” type, provides the product stock management service of the system.

The product stock management service provided by the system 1 is made accessible to users USER via the network IP. The users USER communicate with the product stock management service via their computer devices UD, such as Smartphones, tablets and/or computers, connected to the Internet network IP. The computer devices UD access the Internet network IP and the computer server SRC, either via a local data communication network, for example of the “Wi-Fi” type (cf. data communication links L1, L2 and L3 in FIG. 1), or via a cellular radiotelephony data communication network, for example of the “3G,” “4G” or “5G” type (cf. data communication links L4 and L3 in FIG. 1). In this embodiment, a router modem BOX, referred to as “Internet box,” establishes the local data communication network of the “Wi-Fi” type, denoted RWF in FIG. 1, and obtains access to the Internet network IP. The router modem BOX will typically be of the type referred to as “ADSL” (“Asymmetric Digital Subscriber Line”), optical, satellite, and/or cellular radiotelephony in “3G,” “4G” or “5G” mode.

The software system SW comprises software modules denoted GSP, WB and AP in FIG. 1. In this case, the software module GSP in particular ensures functions of stock management GS, drawing up shopping lists LC, and shopping orders CDE. The software module GSP could also include a function of suggesting recipes depending on the product stocks available, and an expiry date warning function for perishable products. The software module WB in particular implements an Internet platform, also referred to as “web platform,” having a user interface. The software module AP is a programming interface, referred to as “API” (for “Application Programming Interface”).

In order to access the product stock management service, the user USER typically uses a dedicated software application APPLI which is installed on their Smartphone or tablet, and which communicates with the software module GSP via the interface AP. The user USER may also use an Internet browser in one of the computer devices UD in order to access the service via the Internet network IP.

In addition to the hardware and software means described above, the system 1 according to the invention comprises containers RC and a connected weighing device BC, referred to as “connected scales” in the remainder of the description.

The containers RC contain the products of which the stocks must be managed by the system 1. Each container RC is associated with a specific product, which may be a food product or a non-food product. Thus, the products may be very varied and may comprise, for example, coffee pods, pasta, sugar cubes, caster sugar, washing powder or dishwasher tablets, coffee filters, makeup removal wipes, etc. Typically, the user USER assigns a product to a container RC by means of the dedicated software application APPLI, and can modify this assignment.

The containers RC may be very varied, such as boxes, jars, bottles, flexible sachets, original packaging in which the products are sold, etc. The transparent glass containers will have the advantage of allowing direct recognition, by the user USER, of the product contained. The containers RC may comprise a cover CO which ensures hermetic closure.

As shown in FIG. 2, a passive tag TAG of the “RFID” type (“Radio Frequency Identification”) is associated with each container RC. The identification number of the container RC is recorded in the tag TAG.

According to the invention, the tag TAG must be located at a certain distance DL from a placement surface PF of the container RC. The placement surface PF is the surface of the container RC which is intended to be placed on a weighing surface SP of the connected scales BC. In order that the tag TAG can be read reliably by a radio-identification reader module included in the connected scales BC, the location distance DL must be less than a radio detection height DR from the weighing surface SP. The radio detection height DR is connected to the radio detection range of the radio-identification reader module of the connected scales BC, and corresponds to the height of a detection volume VD represented schematically in FIG. 2.

In the three containers, denoted RC1 to RC3, shown in the example of FIG. 2, the placement surface PF is the outer surface of a bottom wall of the containers. In the container RC1, the tag TAG is fixed directly to the placement surface PF, having a location distance DL=0, which satisfies the requirement DL<DR. In the containers RC2 and RC3, the tag TAG is fixed to a lateral wall thereof, having a location distance DL<DR.

It will be noted that the tag TAG will not necessarily be fixed to the container RC, but could also be borne by an accessory associated with the container. Thus, for example, the tag TAG could be borne by a clamp, or a clip, which is fixed to the container RC.

The tests and simulations carried out by the inventive entity have shown that a radio detection height DR of between 2 cm and 3.5 cm allows for good flexibility for the location distance DL of the tag TAG, while keeping the radio-identification reader module in a low power class. A radio-identification reader module which allows for a lesser radio detection height DR, typically of between 0.5 cm and 2 cm, can also be selected in some applications of the invention.

The connected scales BC allow for functions for quantification of the products in the containers RC by means of weighing operations thereof. The connected scales BC are in data communication with the computer server SRC via the local network RWF, the router modem BOX and the Internet network IP (cf. data communication links L5, L2 and L3 in FIG. 1). The connected scales BC, via the local network RWF, could also be in data communication with the software application APPI installed in the computer device UD, such as a Smartphone. Indeed, using the application APPLI, the user USER can configure the connected scales BC, in particular during a first startup thereof, via a data communication link (cf. data communication links L1 and L5) on the local network RWF. It will be noted that this configuration of the connected scales BC can also be carried out by the user USER via the Internet network IP, by accessing a configuration function on their user interface of the Internet platform WB.

As can be seen in FIGS. 1 and 3, the connected scales BC in particular comprise a weighing surface SP, a display screen DY, as well as at least one button TO and an indicator light VO.

With reference to FIG. 3, the connected scales BC are designed so as to be able to also ensure a conventional weighing function when a container AR other than a container RC is placed on the weighing surface SP. The detection of a weight on the weighing surface SP, together with the absence of detection of a passive tag TAG, allows the connected scales BC to identify the placement of a container AR. The weight measured is then displayed directly on the display screen DY.

According to the invention, the containers RC and the connected scales BC comprise specific means, and are manipulated by the user USER in a specified manner, which makes it possible to inform the software module GSP, more precisely the stock management function GS, of the movements of the product stocks.

The user USER performs weighing of a container RC on the connected scales BC after any change in the contents of the container RC. Thus, after removal by the user USER of an amount of product, in number or weight, in a container RC, the user USER must weigh the container RC on the connected scales BC before storing it in its storage space ER (cf. FIG. 1). In the same way, the user USER must weigh the container RC on the connected scales BC after any addition of product into the container RC, before storing it in its storage space ER.

The connected scales BC recognize the product which is being weighed, by virtue of reading the tag TAG of the container RC which provides them with a specific identification number. Said specific identification number and the weight measurement of the container RC are transmitted by the connected scales BC to the stock management function GS. On the basis of the identification number, the stock management function GS recovers, in the database DB, the type of product in the container RC and an empty weight of the container RC. The weight of the product in the container RC is thus calculated by the stock management function GS, which uses it in order to keep an exact account of available stocks up to date. The weight of the product calculated is also transmitted to the connected scales BC by the stock management function GS, for display intended for the user USER.

It will be noted that all the weighing operations must be carried out with the container RC provided with its cover CO, so as not to distort the measurement of the weight of the product in the container.

When the container RC contains a product quantified by units, such as coffee pods, the stock is managed by number of units. The number of units of product present in the container RC is calculated by dividing the product weight determined by the weighing operation, by the weight of a unit of product, referred to hereinafter as the “unit weight.” The unit weights of the products managed by the system 1 are measured by means of the connected scales BC, by activation of a dedicated configuration function of the system 1. The unit weights of the products are typically stored in the database DB and are accessible to the stock management function GS. The stock management function GS calculates the number of units of product for the stock account. Furthermore, the stock management function GS transmits the number of units of product calculated, to the connected scales BC, for display thereof on the screen DY. When the container RC contains a product quantified by weight, the stock is managed directly by weight, and it is the weight of product in the container RD which is displayed on the screen DY.

With reference also to FIGS. 4 and 5, the electronic architecture and the functioning of the connected scales BC is now described in further detail below.

An electronic board PC, shown schematically in FIG. 4, is included in the connected scales BC and carries various components necessary for the functioning thereof. As shown in FIG. 4, the electronic board PC essentially comprises a microcontroller 2 which is equipped with human-machine interface means 3, a radio communication module 4, a radio-identification reader module 5, a weight measuring bridge 6, an autonomous electrical supply unit 7, and an accelerometer 8.

The microcontroller 100 essentially comprises a microprocessor CPC, a random access memory RAM, a rewritable memory MEM, and input/output ports P0 to P5. The RAM memory is the working memory of the microprocessor CPU. The rewritable memory MEM typically hosts an elementary system referred to as “BIOS” which managed the inputs/outputs of the microprocessor, a microprogram MP, and a data storage zone DATA.

The microprogram MP manages the general functioning of the connected scales BC. The microprogram MP integrates the control logic of the connected scales BC, processes the weight measurement data, and manages the various data exchanges with the computer server SRC of the system 1 and the computer device UD of the user USER. The zone DATA stores various data required for the microprogram MP and for the functioning of the system 1. The input/output ports P0 to P5 are connected to the microprocessor CPU via an internal data communication bus (not shown).

The human/machine interface means are interfaces with the microcontroller 2 via the input/output port P0, and in this case essentially comprises the above-mentioned components such as the display screen DY, the button TO and the indicator light VO, as well as a miniature loudspeaker HP. The display screen DY is typically a display screen of the “LCD” type. The button TO is typically a capacitive button, and the indicator light VO typically comprises one or more electroluminescent diodes, referred to as “LED.” Said human/machine interface means allow an interactive dialog between the user and the connected scales 2, in particular upon initial startup of the connected scales 2 by the user USER and during the weighing operations.

In this case, the radio communication module 4 is a radio communication transmitter/receiver of the Wi-Fi type (“Wireless Fidelity”), and is interfaced with the microcontroller 2 via the input/output port P1. A radio communication transmitter/receiver of the Wi-Fi/Bluetooth type could also be used. The radio communication module 4 allows wireless data communication links between the connected scales BC, the router modem BOX and the computer device UC, via the local network RWF.

In this case, the radio-identification reader module 5 is an RFID (“Radio Frequency Identification”) micro-reader, and is interfaced with the microcontroller 2 via the input/output port P2. The radio-identification reader module 5 is intended for reading the passive tag TAG of the container RC, which reading allows the stock management function GS to identify the product in question and to obtain the empty weight of the container RC.

The weight measuring bridge 6 is typically a Wheatstone bridge, incorporating strain gages JC, and is interfaced with the microcontroller 2 via the input/output port P3. The weight measuring bridge 6 provides an analog measurement MES of the weight of the container RC. Analog-to-digital conversion means are typically associated with the bridge P3, in order to convert the analog weight measurement MES into digital data which can be used by the microprogram MP.

The autonomous electrical supply unit 7 is interfaced with the microcontroller 2 via the input/output port P4. The electrical supply unit 7 comprises a rechargeable battery 70 and voltage converters (not shown) which provide supply voltages Valim required for the functioning of the various components of the electronic board PC. The rechargeable battery 70 is typically a battery of the lithium ion type. The charging of the battery 70 is carried out by means of a standard AC-DC electric charger, denoted 71, which can be plugged into a “USB” (“Universal Serial Bus”) socket, denoted USBa, of the electronic board PC. The socket USBa is connected to the electrical supply unit 7 and to a bus port USB of the microcontroller 2. A wired data communication link can thus be established between the microcontroller 2 and a computer device (computer), for example for the purpose of updating, configuration or troubleshooting of the connected scales BC.

The accelerometer 8 is typically a three-axis micro-accelerometer of the linear type, and is interfaced with the controller 2 via the input/output port P5. The accelerometer 8 makes it possible to detect movements of the connected scales BC due to manipulations by the user USER, so as to control a function of putting the connected scales BC on standby. Said function of putting the connected scales BC on standby is intended to extend the period of autonomy of the electrical supply thereof. A lack of movement of the connected scales BC during a predetermined waiting time is detected by the microprogram PM by means of movement information provided by the accelerometer 8. Consecutively, the microprogram PM controls the putting on standby of the connected scales BC by deactivation of supply voltages Valim in the electrical supply unit 7. This putting on standby of the connected scales BC reduces to a minimum the electrical consumption thereof, and thus saves the electrical energy contained in the rechargeable battery 70.

When a movement of the connected scales BC is detected by the microprogram PM, by means of the movement information provided by the accelerometer 8, this controls the activation of all the supply voltages Valim in the electrical supply unit 7, so as to wake the connected scales BC.

The algorithm of FIG. 5 shows, in a simplified manner, the functioning of the connected scales BC during weighing operations, as controlled by the process of the microprogram MP. Said algorithm comprises functional blocks BK1 to BK11 which are described below.

In the conditional block BK1, the connected scales BC are in the standby state. The logic state of a movement signal ACC produced from the movement information provided by the accelerometer 8 is verified in a loop by the process. When the movement signal ACC is in an inactive logic state “0,” indicating an absence of movement of the connected scales BC, an output Y of the block BK1 is thus activated, and controls looping on the block BK1 which keeps the connected scales BC in the standby state. When the movement signal ACC is in an active logic state “1,” indicating a movement of the connected scales BC, an output N of the block BK1 is thus activated, and controls wakeup of the connected scales BC. Following wakeup of the connected scales BC, the process runs from the conditional block BK2.

The conditional block BK2 has the function of detecting the placement of a container on the weighing surface SP. The placement of a container is detected by the process by means of the weight measurement provided by the measuring bridge 6. When no container is placed on the weighing surface SP, a container placement signal POS is in the inactive logic state “0,” and an output N of the block BK2 is activated. If said output N has stayed in the inactive logic state “0” for a waiting time TEMPO, the process controls looping on the block BK1 in order to return the connected scales BC to the standby state. When a container is placed on the weighing surface SP, the container placement signal POS is in the active logic state “1,” and an output Y of the block BK2 is then activated. The activation of said output Y allows the execution of the conditional block BK3 by the process.

The conditional block BK3 detects whether the container is a container RC of a product managed by the system 1, or is another container AR (cf. FIG. 3). During placement by the user USER of the container onto the weighing surface SP, if the container is a container RC, the tag TAG thereof has been detected and read by the radio-identification reader module 5, and an output Y of the block BK3 is then activated. In the opposite case, it is a different container AR, and it is the output N of the block BK3 which is then activated.

The activation of the output Y of the block BK3 allows the successive execution of the functional blocks BK4 to BK8 by the process. The activation of the output N of the block BK3 allows the successive execution of the functional blocks BK8 to BK11 by the process.

The functional blocks BK4 to BK8 of the process are set out below.

In the conditional block BK4, an identification number ID_RC, which has been read in the tag TAG as indicated above, is stored by the process.

The block BK5 relates to the operation of weighing the container RC, which measures a total weight PD_RC of the container RC.

The block BK6 relates to sending the identification number ID_RC and the total weight PD_RC to the stock management function GS of the software module GSP. The stock management function GS recovers, in the database DB, an empty weight PV_RC of the container RC, from the identification number ID_RC, and subtracts this from the total weight PD_RC in order to obtain a weight of the product measured PC_RC. The stock management GS function identifies the content of the container RC as being a product quantified by weight or a product quantified by number of units, from the identification number ID_RC received. If the identified content is a product quantified by weight, the stock management function GS returns, to the connected scales BC, the weight of the product measured PC_RC, for display thereof on the screen DY. In the opposite case, the stock management function GS returns, to the connected scales BC, a number of units of product Nb_RC present in the container RC, for display thereof on the screen DY. The number of units of product Nb_RC has been calculated by the stock management function GS, by dividing the weight of product measured PC_RC by the unit weight of the product which is extracted from the database DB from the identification number ID_RC.

The block BK7 relates to the display on the screen DY of the weight of product measured PC_RC or of the number of units of product Nb_RC returned by the stock management function GS.

The block BK8 relates to the display on the screen DY of an instruction or a message INST1 intended for the user USER, such as “the stock is updated. Store the container.” The process then returns the connected scales BC into the standby state, by looping on the block BK1 at the end of the waiting time TEMPO.

The functional blocks BK9 to BK11 of the process are set out below.

The block BK9 relates to the display on the screen DY of a message INST2 intended for the user USER, such as “Container not recognized. Display of total weight.” Such a message informs the user that the container AR placed on the weighing surface SP of the connected scales BC is not a container managed by the system 1, and that it is the total weight of the container and of the product contained which will be displayed.

The block BK10 relates to the operation of weighing the container AR, which measures a total weight PD_AR of the container AR.

The block BK11 relates to the display on the screen DY of the measured weight PC_AR of the container AR. The process then returns the connected scales BC into the standby state, by looping on the block BK1 at the end of the waiting time TEMPO.

It will be noted that different variants are possible, and are within the grasp of a person skilled in the art.

Thus, in other embodiments, the identification of the containers can be performed using the “NFC” (“Near Field Communication”) technology, instead of the “RFID” technology. Local data communication of the “Bluetooth” type can also be used between the computer device of the user and the connected scales.

The connected scales can also be recharged by induction recharging means. In a more economical embodiment, the connected scales will not comprise a rechargeable electric battery supply, and will be supplied by onboard electric batteries.

The sock management function can be implanted, in part or entirely, not in the computer server but rather in the data storage zone (cf. DATA in FIG. 4) of the microcontroller of the connected scales, so as to reduce the data exchanges between the connected scales and the computer server. Data updates will thus be carried out regularly, between the connected scales and the computer server. Furthermore, the empty weight of the container can also be stored locally in the passive tag thereof, for calculation of the product weight directly by the connected scales.

It will be noted that the system of the invention is not limited exclusively to domestic use, and can for example be adapted for stock management in a professional context, for example in the retail trade, in pharmacies, or the like.

Of course, the invention is not limited to the embodiments that have been described here by way of example. Depending on the applications of the invention, a person skilled in the art could make various amendments and variants which are within the scope of the invention.

1. System for managing product stocks comprising a plurality of products stored in product containers, a computer server hosting a product stock management software module and connected to an extended data communication network, a weighing device interconnected with said computer server via a wireless data communication link and via said extended data communication network, and in data communication with said product stock management software module, and a user computer device connected to said computer server via said extended data communication network and hosting a software application and in data communication with said product stock management software module, said said product containers each being provided with an identification tag storing an identification number, and said weighing device (RC) comprising an identification reader module, and said weighing device comprising means arranged so as to control reading of said identification number in said identification tag (TAG) by said identification reader module during an operation of weighing said product container and to transmit a weight measurement of said product container and said read identification number to said computer server hosting said product stock management software module, wherein said identification reader module is a radio-identification reader module and said identification tag is a radio-identification tag having a location distance with respect to a placement surface of said product container which is at most equal to a radio detection height of said radio-identification reader module from a weighing surface of said weighing device, and in that said weighing device comprises an accelerometer and means arranged so as ensure that said weighing device is put on standby, or woken up, on the basis of movement information supplied by said accelerometer.

2. System for managing product stocks according to claim 1, characterized in that said radio-identification reader module is included in a power class allowing a radio detection height of between 2 cm and 3.5 cm.

3. System for managing product stocks according to claim 1, characterized in that said radio-identification reader module is included in a power class allowing a radio detection height of between 0.5 cm and 2 cm.

4. System for managing product stocks according to claim 1, characterized in that said extended data communication network is the Internet network.

5. System for managing product stocks according to claim 1, characterized in that said user computer device is a Smartphone, a tablet, or a computer connected to said Internet network.

6. System for managing product stocks according to claim 1, characterized in that said radio-identification tag and said radio-identification reader module are of the “RFID” type.

7. System for managing product stocks according to claim 1, characterized in that it also comprises a router modem which obtains a local data communication network and access to said extended data communication network, said weighing device being interconnected with said computer server via said local data communication network.

8. System for managing product stocks according to claim 7, characterized in that said router modem and said local data communication network are of the “Wi-Fi” type, and said weighing device comprises a radio communication module of the “Wi-Fi” type.

9. System for managing product stocks according to claim 8, characterized in that said router modem is of the type referred to as “ADSL,” optical, satellite, and/or cellular radiotelephony in “3G,” “4G” or “5G” mode.

10. System for managing product stocks according to claim 1, characterized in that it comprises a local data communication link between said weighing device and said user computer device hosting said software application, said local data communication link being used by a configuration function of said weighing device actuated by means of said software application.
